(19) United States
(12) Patent Application Publication
(10) Pub. No.: US 2026/0321829 A1
(43) Pub. Date: Oct. 15, 2026

(54) POUCH-TYPE BATTERY CELL

(71) Applicant: SK On Co., Ltd., Seoul (KR)

(72) Inventor: Jun Ho JANG, Daejeon (KR)

(21) Appl. No.: 19/646,607

(22) Filed: Apr. 14, 2026

(30) Foreign Application Priority Data
Apr. 14, 2025 (KR) 10-2025-0048213
May 2, 2025 (KR) 10-2025-0058381
May 2, 2025 (KR) 10-2025-0058446
Mar. 17, 2026 (KR) 10-2026-0048012

(51) Int. Cl. H01M 50/184; H01M 50/105; H01M 50/119; H01M 50/176; H01M 50/186

(52) U.S. Cl. CPC H01M 50/184; H01M 50/105; H01M 50/119; H01M 50/176; H01M 50/186

(57) ABSTRACT

The present disclosure relates to a pouch-type battery cell. The pouch-type battery cell includes: a cell pouch having an upper case and a lower case accommodating an electrode assembly; an electrode tab protruding from the electrode assembly between the upper case and the lower case; a first sealant layer interposed between the upper case and the electrode tab, at a position corresponding to the upper case and the electrode tab; a second sealant layer interposed between the lower case and the electrode tab, at a position corresponding to the lower case and the electrode tab; a first taping portion covering a region of the upper case and a region of the first sealant layer; and a second taping portion covering a region of the lower case and a region of the second sealant layer.

### CROSS-REFERENCE TO RELATED PATENT APPLICATION

The present application claims priority under 35 U.S.C. § 119(a) to Korean patent application number 10-2025-0048213 filed on Apr. 14, 2025, Korean patent application number 10-2025-0058446 filed on May 2, 2025, Korean patent application number 10-2025-0058381 filed on May 2, 2025, and Korean patent application number 10-2026-0048012 filed on Mar. 17, 2026, in the Ministry of Intellectual Property, the entire disclosure of which is incorporated by reference herein.

### BACKGROUND OF THE INVENTION

### 1. Field

The present disclosure relates to a pouch-type battery cell.

### 2. Description of the Related Art

Demand for secondary batteries as energy power sources driving various electronic devices such as smartphones, laptops, vehicles, and drones is rapidly increasing. In particular, research on battery cells as secondary batteries for driving vehicles and the like is being actively conducted.

Battery cells applied to electric vehicles and the like may be modularized by electrically connecting a plurality of battery cells due to the need for high output and large capacity. An electric vehicle may include a battery module in which a plurality of such battery cells are arranged to obtain high power.

For example, when a battery module is configured by connecting a plurality of battery cells in series/parallel, a battery module including at least one battery cell may be configured, and a battery pack may be configured by adding other components using at least one such battery module.

Generally, such a battery cell may include a case accommodating an electrode assembly, electrode tabs protruding from the case at front and rear ends of the case, and a cell pouch formed at an edge of the case.

For example, the cell pouch may include a predetermined metal layer, and the metal layer may be exposed at an end portion of the cell pouch. If an electrical connection occurs between the exposed metal layer of the cell pouch and the electrode tab, the cell pouch may carry an electrical potential, causing corrosion of the cell pouch and reducing a service life of the battery cell.

Accordingly, development of a pouch-type battery cell capable of preventing an electrical connection between the metal layer of the cell pouch and the electrode tab is desired.

### SUMMARY OF THE INVENTION

According to an aspect of the present disclosure, a pouch-type battery cell having improved insulation performance is provided.

According to another aspect of the present disclosure, a pouch-type battery cell having improved durability is provided.

According to another aspect of the present disclosure, process efficiency in a manufacturing process of a pouch-type battery cell is improved.

To achieve the above-described technical objectives, the present disclosure provides a pouch-type battery cell.

In an embodiment of the present disclosure, a pouch-type battery cell includes: a cell pouch having an upper case and a lower case accommodating an electrode assembly; an electrode tab protruding from the electrode assembly between the upper case and the lower case; a first sealant layer interposed between the upper case and the electrode tab, at a position corresponding to the upper case and the electrode tab; a second sealant layer interposed between the lower case and the electrode tab, at a position corresponding to the lower case and the electrode tab; a first taping portion covering a region of the upper case and a region of the first sealant layer; and a second taping portion covering a region of the lower case and a region of the second sealant layer.

In an embodiment of the present disclosure, each of the upper case and the lower case may include a metal layer interposed between a first polymer layer and a second polymer layer.

In an embodiment of the present disclosure, the first taping portion may include a first base film and a first adhesive layer applied to a surface of the first base film, and the second taping portion may include a second base film and a second adhesive layer applied to a surface of the second base film.

In an embodiment of the present disclosure, the first adhesive layer and the second adhesive layer may include an insulating material.

In an embodiment of the present disclosure, the first adhesive layer may face and surround a region of the upper case, an end portion of the upper case, and a region of the first sealant layer, and the second adhesive layer may face and surround a region of the lower case, an end portion of the lower case, and a region of the second sealant layer.

In an embodiment of the present disclosure, the first adhesive layer may have a stepped shape forming a level difference with respect to the region of the upper case and the region of the first sealant layer.

In an embodiment of the present disclosure, the first adhesive layer may continuously extend from the region of the upper case to the region of the first sealant layer.

In an embodiment of the present disclosure, the second adhesive layer may have a stepped shape forming a level difference with respect to the region of the lower case and the region of the second sealant layer.

In an embodiment of the present disclosure, the second adhesive layer may continuously extend from the region of the lower case to the region of the second sealant layer.

In an embodiment of the present disclosure, the first adhesive layer and the second adhesive layer may be fusible by heat.

In an embodiment of the present disclosure, a width of the first sealant layer and the second sealant layer may be greater than a width of the electrode tab.

In an embodiment of the present disclosure, the first adhesive layer and the second adhesive layer may contact each other at a portion excluding a position where the upper case and the lower case respectively correspond to the first sealant layer and the second sealant layer.

In an embodiment of the present disclosure, a thickness of the first base film may be less than a distance from a surface of the first base film on which the first adhesive layer is applied to the region of the first sealant layer.

In an embodiment of the present disclosure, a thickness of the second base film may be less than a distance from a surface of the second base film on which the second adhesive layer is applied to the region of the second sealant layer.

In an embodiment of the present disclosure, the metal layer of the upper case may not be exposed to an exterior by the first adhesive layer, and the metal layer of the lower case may not be exposed to the exterior by the second adhesive layer.

According to an embodiment of the present disclosure, insulation performance of a pouch-type battery cell may be improved.

According to another embodiment of the present disclosure, durability of a pouch-type battery cell may be improved.

According to another embodiment of the present disclosure, process efficiency in a manufacturing process of a pouch-type battery cell may be improved.

Meanwhile, the pouch-type battery cell according to the present disclosure may be widely applied in the fields of green technology such as electric vehicles, battery charging stations, energy storage systems (ESS), and photovoltaics and wind power that utilize battery cells.

In addition, the pouch-type battery cell according to the present disclosure may be used in eco-friendly mobility including electric vehicles and hybrid vehicles aimed at preventing climate change by suppressing air pollution and greenhouse gas emissions.

### BRIEF DESCRIPTION OF THE DRAWINGS

FIG. 1 is a perspective view schematically illustrating a pouch-type battery cell according to an embodiment of the present disclosure.

FIG. 2 is a view schematically illustrating regions covered by a first taping portion of a pouch-type battery cell according to an embodiment of the present disclosure.

FIG. 3 is an exploded perspective view schematically illustrating a pouch-type battery cell according to an embodiment of the present disclosure.

FIG. 4 is a cross-sectional view of a cell pouch according to an embodiment of the present disclosure.

FIG. 5 is a cross-sectional view taken along line A-A of FIG. 1.

FIGS. 6A-6C are views schematically illustrating a method of manufacturing a pouch-type battery cell according to an embodiment of the present disclosure.

FIG. 7 is another perspective view schematically illustrating a pouch-type battery cell according to an embodiment of the present disclosure.

FIG. 8 is a cross-sectional view taken along line B-B of FIG. 7.

### DETAILED DESCRIPTION

Hereinafter, a pouch-type battery cell 1 according to an embodiment of the present disclosure will be described through exemplary embodiments of the present disclosure with reference to the accompanying drawings.

Prior to the description, when a component is described as "including" a certain element, this does not exclude other elements but may further include other elements, unless specifically stated to the contrary.

In addition, in various embodiments, components having the same configuration are representatively described in one embodiment using the same reference numerals, and only different components are described in other embodiments.

Structural or functional descriptions of embodiments disclosed in this specification or application are merely exemplified to describe embodiments according to the technical concept of the present disclosure. Embodiments according to the technical concept of the present disclosure may be implemented in various forms other than the embodiments disclosed in this specification or application, and the technical concept of the present disclosure is not to be construed as being limited to the embodiments described in this specification or application.

Hereinafter, a pouch-type battery cell 1 according to various embodiments of the present disclosure will be described in more detail with reference to the following drawings.

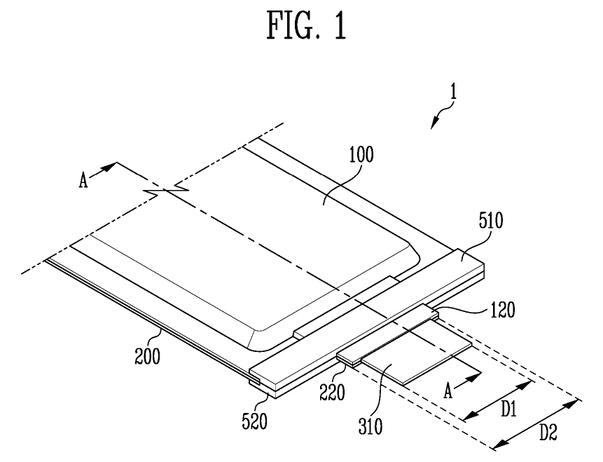

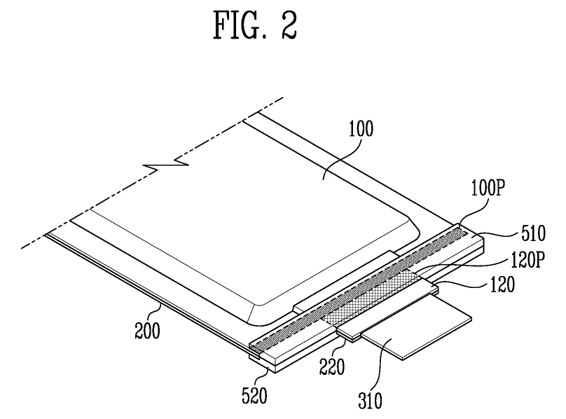

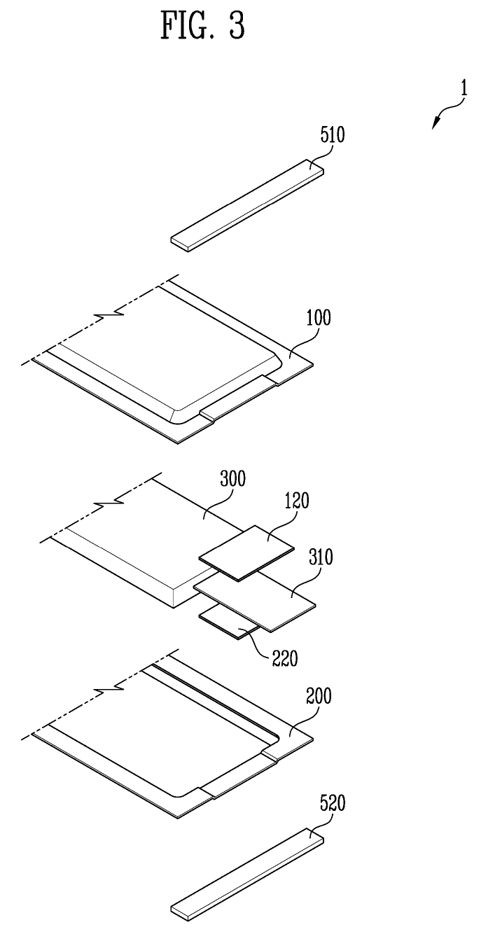

FIG. 1 is a perspective view schematically illustrating a pouch-type battery cell 1 according to an embodiment of the present disclosure. FIG. 2 is a view schematically illustrating regions 100P and 120P covered by a first taping portion 510 of a pouch-type battery cell 1 according to an embodiment of the present disclosure. In addition, FIG. 3 is an exploded perspective view schematically illustrating a pouch-type battery cell 1 according to an embodiment of the present disclosure.

In an embodiment of the present disclosure, the pouch-type battery cell 1 may include a cell pouch including an upper case 100 and a lower case 200 accommodating an electrode assembly, and an electrode tab 310 protruding from the electrode assembly between the upper case 100 and the lower case 200.

In addition, the pouch-type battery cell 1 may include a first sealant layer 120 interposed between the upper case 100 and the electrode tab 310 at a position corresponding to the upper case 100 and the electrode tab 310, and a second sealant layer 220 interposed between the lower case 200 and the electrode tab 310 at a position corresponding to the lower case 200 and the electrode tab 310.

In addition, the pouch-type battery cell 1 may include a first taping portion 510 covering a region 100P of the upper case 100 and a region 120P of the first sealant layer 120, and a second taping portion 520 covering a region 200P of the lower case 200 and a region 220P of the second sealant layer 220.

For example, the pouch-type battery cell 1 may be a secondary battery capable of being charged and discharged a plurality of times. For example, the secondary battery may be one of a lithium cobalt battery, a lithium high-nickel battery, a lithium iron phosphate battery, a lithium-ion battery, a lithium polymer battery, a lithium-sulfur battery, a nickel-metal hydride battery, a nickel-cadmium battery, a sodium battery, and an all-solid-state battery, but is not limited thereto and may be modified to various types of secondary batteries.

In addition, the electrode assembly 300 may include a positive electrode plate, a negative electrode plate, and a separator. The cell pouch is configured to package the electrode assembly 300 and may be formed of a laminate sheet including a resin layer and a metal layer 100b.

For example, the upper case 100 and the lower case 200 may be formed on upper and lower sides, and may be disposed to accommodate the electrode assembly 300 in a space formed between the upper case 100 and the lower case 200.

For example, the electrode tab 310 may be electrically connected to the electrode assembly 300. The electrode tab 310 may be provided as a pair. The pouch-type battery cell 1 according to an embodiment of the present disclosure may have a structure in which two electrode tabs 310 face each other and protrude from both ends of a short-side of the cell pouch.

For example, the upper case 100 and the lower case 200 may be formed to correspond to each other on upper and lower sides and may be sealed by thermal fusion bonding or the like. Through this configuration, an electrical connection between the electrode assembly 300 accommodated inside the cell pouch and an exterior may be blocked.

For example, the upper case 100 may include a short-side end portion and a long-side end portion, and the lower case 200 may include a short-side end portion and a long-side end portion.

For example, the cell pouch including the upper case 100 and the lower case 200 may accommodate the electrode assembly 300 together with an electrolyte. For example, the electrolyte may include a carbonate-based solvent. For example, the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like.

For example, the carbonate-based solvent can readily penetrate into polymers having relatively large interchain distances, such as polystyrene. In addition, for example, the electrolyte may be in a liquid, solid, or gel phase.

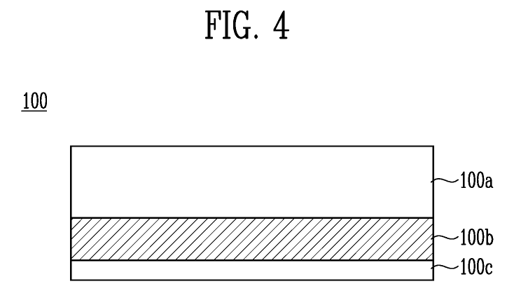

FIG. 4 is a cross-sectional view of the upper case 100 of the cell pouch according to an embodiment of the present disclosure.

In an embodiment of the present disclosure, each of the upper case 100 and the lower case 200 may include a metal layer 100b interposed between a first polymer layer 100c and a second polymer layer 100a.

For example, the upper case 100 may be formed by sequentially stacking a first polymer layer 100c, a metal layer 100b, and a second polymer layer 100a. The second polymer layer 100a formed at an outermost portion of the battery cell 1 and the first polymer layer 100c formed at an inner portion of the pouch-type battery cell 1 may form insulating layers. Accordingly, the metal layer 100b formed between the first polymer layer 100c and the second polymer layer 100a may be blocked from being electrically connected to an exterior.

For example, although the lower case 200 is not specifically illustrated, the lower case 200 described above may also have a structure in which a first polymer layer, a metal layer, and a second polymer layer are sequentially stacked, which is substantially the same as the upper case 100.

Although the following detailed description is given based on the upper case 100, the following description may equally apply to the lower case 200, which may have a structure substantially the same as the upper case 100.

For example, the first polymer layer 100c may use a polymer material that does not deteriorate in processability during forming of an accommodation portion of the cell pouch. For example, the first polymer layer 100c preferably has characteristics of not having wettability to the electrolyte injected into the accommodation space of the cell pouch and having low swelling property.

For example, the first polymer layer 100c preferably has a relatively low melting point so that the first polymer layer 100c may be bonded at a lower temperature during sealing of the cell pouch. As bondability increases, sealing strength of a sealing portion may be improved and electrolyte penetration may be suppressed.

For example, the metal layer 100b may secure mechanical strength of the upper case 100 and may prevent gas and moisture from outside of the battery cell 1 from entering an interior of the battery cell 1. For example, the metal layer 100b may use an aluminum layer. For example, in addition to the aluminum layer, a metal layer 100b using various metal materials having the above-described characteristics may also be adopted. For example, in the case of the aluminum layer, it may be advantageous in that the aluminum layer may secure a predetermined level or more of mechanical strength while being light in weight and improving electrochemical properties of the electrode assembly 300 and the electrolyte as well as heat dissipation.

For example, the second polymer layer 100a is formed of a material having electrical insulation properties and is formed on an outer side of the metal layer 100b. Here, the outer side may refer to a portion positioned in a direction opposite to a direction in which the electrode assembly 300 is positioned based on the metal layer 100b, that is, a portion positioned in an outward direction of the battery cell 1.

For example, based on the upper case 100 illustrated in FIGS. 1-3, the outer side of the aluminum layer 103 may refer to an upper side of the aluminum layer 103. Conversely, based on the lower case 200, the outer side of the aluminum layer 203 may refer to a lower side of the aluminum layer 203.

For example, the second polymer layer 100a is disposed on an outer side of the pouch-type battery cell 1 relative to the metal layer 100b to protect the battery from the exterior, while enabling the electrode assembly 300 and the metal layer 100b to be electrically insulated from the exterior.

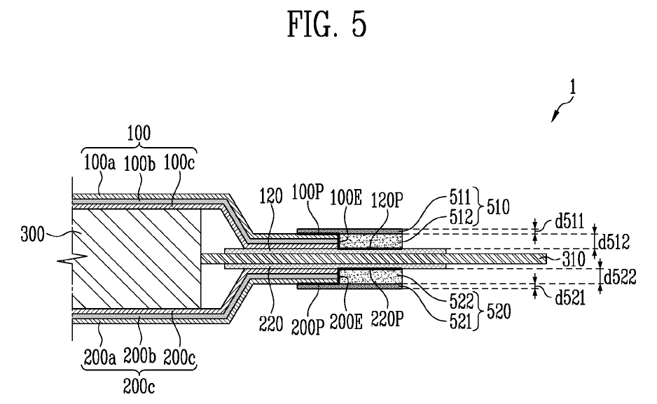

FIG. 5 is a cross-sectional view taken along line A-A of FIG. 1.

In an embodiment of the present disclosure, the first taping portion 510 may include a first base film 511 and a first adhesive layer 512 applied to a surface of the first base film 511, and the second taping portion 520 may include a second base film 521 and a second adhesive layer 522 applied to a surface of the second base film 521. In addition, the first adhesive layer 512 and the second adhesive layer 522 may include an insulating material.

For example, the first taping portion 510 may have a structure in which a first base film 511 and a first adhesive layer 512 formed by applying an adhesive component to a surface of one side of the first base film are stacked. Meanwhile, the second taping portion 520 may also have a structure in which a second base film 521 and a second adhesive layer 522 formed by applying an adhesive component to a surface of one side of the second base film are stacked, which is substantially the same as the first taping portion 510.

Although the following exemplary description is given based on the first taping portion 510, the following description may equally apply to the second taping portion 520, which may have a structure substantially the same as the first taping portion 510.

For example, the first base film 511 may use a resin having elasticity (for example, thin-film rubber). For example, the first base film 511 may use a polyester film. In addition, the first adhesive layer 512 may be formed by applying an adhesive component to a surface of one side of the first base film 511.

For example, the first base film 511 and the first adhesive layer 512 may include a material that imparts insulating properties. Accordingly, a region covered by the first taping portion 510 may be electrically insulated from the exterior or surrounding components.

For example, the first adhesive layer 512 may include a material that is curable by ultraviolet light in a liquid state having a predetermined viscosity. For example, the first adhesive layer 512 may use a paint-based material or an acrylic-based material such as epoxy, silicone, or urethane.

For example, the first adhesive layer 512 may include a material that imparts thermal conductivity. For example, the thermally conductive material may use a ceramic material such as alumina or silica. Through this configuration, thermal conductivity in the first adhesive layer 512 formed of a resin component may be improved.

For example, a magnitude of stress applied to the first taping portion 510 may be non-uniform, or a large stress may be applied to a part of the first base film 511, and thus the first base film 511 may reach a point of fracture. Alternatively, as the pouch-type battery cell 1 is used, deterioration of the first base film 511 may progress due to vibration or thermal shock, and a part of the first base film 511 where stress is concentrated may be fractured. In this regard, because the first adhesive layer 512 has thermal conductivity, even when the first base film 511 is fractured, the first adhesive layer 512 may still be maintained in the region covered by the first taping portion 510. Accordingly, insulating properties of the first taping portion 510 may continue to be secured.

In an embodiment of the present disclosure, the first adhesive layer 512 and the second adhesive layer 522 may be fused by heat.

For example, the first adhesive layer 512 may use a hot-melt layer that is fusible by heat.

For example, the hot-melt layer may serve to maintain the first base film 511 adhered to an adherend of the pouch-type battery cell 1. As described above, the hot-melt layer may be pre-applied to the first base film 511 and adhered to the pouch-type battery cell 1 as an integrated first taping portion 510.

Alternatively, the hot-melt layer may be a separate layer from the first base film 511. A method of first adhering the hot-melt layer to the pouch-type battery cell 1 and then attaching the first base film 511 thereon to form the first taping portion 510 is also possible.

For example, the hot-melt layer may be manufactured from a polyolefin-based resin such as polyethylene or polypropylene, a thermoplastic resin such as ethylene vinyl acetate, polyester, or polyamide, or a thermosetting resin such as a polyurethane-based resin.

For example, because the pouch-type battery cell 1 is frequently sealed by melting the first polymer layer 110c with heat, a melting point of the hot-melt layer is preferably lower than a melting point of the first polymer layer 110c so as not to affect performance of the first polymer layer 110c.

In an embodiment of the present disclosure, the first adhesive layer 512 may face and surround a region 100P of the upper case 100, an end portion 100E of the upper case 100, and a region 120P of the first sealant layer 120. In addition, the second adhesive layer may face and surround a region 200P of the lower case 200, an end portion 200E of the lower case 200, and a region 220P of the second sealant layer 220.

In addition, in an embodiment of the present disclosure, the first adhesive layer 512 may have a stepped shape forming a level difference with respect to the region 100P of the upper case 100 and the region 120P of the first sealant layer 120, and may continuously extend from the region 100P of the upper case 100 to the region 120P of the first sealant layer 120.

In addition, in an embodiment of the present disclosure, the second adhesive layer 522 may have a stepped shape forming a level difference with respect to the region 200P of the lower case 200 and the region 220P of the second sealant layer 220, and may continuously extend from the region 200P of the lower case 200 to the region 220P of the second sealant layer 220.

For example, the first adhesive layer 512 may surround the end portion 100E of the upper case 100 in a direction toward the electrode tab 310, thereby insulating an end of the metal layer 100b.

For example, the first adhesive layer 512 may be formed in a shape continuously extending from the region 100P of the upper case 100 to the region 120P of the first sealant layer 120. One end of the first adhesive layer 512 may be positioned in a region of the cell pouch 110, and the other end of the first adhesive layer 512 may be positioned in the region 120P of the first sealant layer 120.

For example, a surface of the upper case 100 and a surface of the first sealant layer 120 may form a level difference in a height direction. In addition, because the first adhesive layer 512 is a liquid having a predetermined viscosity, the first adhesive layer 512 may be disposed according to positions of the surface of the upper case 100 and the surface of the first sealant layer 120. Accordingly, the first adhesive layer 512 may face and surround the region 100P of the upper case 100, the end portion 100E of the upper case 100, and the region 120P of the first sealant layer 120.

For example, the first adhesive layer 512 may be bent substantially vertically at the end portion 100E of the upper case 100 in an extending direction thereof so as to have a stepped shape forming a level difference in the extending direction.

Accordingly, because the first adhesive layer 512 contacts the region 100P of the upper case 100, the end portion 100E of the upper case 100, and the region 120P of the first sealant layer 120 while facing and surrounding them, the region 100P of the upper case 100, the end portion 100E of the upper case 100, and the region 120P of the first sealant layer 120 are not only not exposed to the exterior, but also no space may exist between them and the first adhesive layer 512.

For example, the upper case 100 may be manufactured through a cutting process, and due to this cutting process, the metal layer 100b formed between the first polymer layer 100c and the second polymer layer 100a may be exposed to the exterior at the end portion 100E of the upper case 100.

For example, when unintended moisture or impurities are interposed between the metal layer 100b exposed to a side and the electrode tab 310, an electrical connection may occur between the metal layer 100b and the electrode tab 310. For example, when an electrical connection occurs between the metal layer 100b and the electrode tab 310, corrosion of the metal layer 100b may be caused due to a potential difference between the metal layer 100b and the electrode tab 310.

For example, the end portion 100E of the upper case 100 adjacent to the electrode tab 310 may be bent due to impact or vibration during a manufacturing process of the battery cell 1, and the end portion 100E of the upper case 100 may contact the electrode tab 310. For example, when the end portion 100E of the upper case 100 and the electrode tab 310 contact each other, an electrical connection may occur between the metal layer 100b and the electrode tab 310. In this case, when an electrical connection occurs between the metal layer 100b and the electrode tab 310, corrosion of the metal layer 100b may be caused due to a potential difference between the metal layer 100b and the electrode tab 310.

Accordingly, by disposing the first taping portion 510 at the end portion 100E of the upper case 100 so that the first adhesive layer 512 of the first taping portion 510 surrounds the end portion 100E of the upper case 100, the metal layer 100b is not exposed to the exterior, and consequently, the end of the metal layer 100b may be electrically insulated.

Accordingly, in an embodiment of the present disclosure, the metal layer 100b of the upper case 100 may not be exposed to the exterior by the first adhesive layer 512, and the metal layer 200b of the lower case 200 may not be exposed to the exterior by the second adhesive layer 522.

Meanwhile, in an embodiment of the present disclosure, a thickness of the first base film 511 may be less than a distance from a surface of the first base film 511 on which the first adhesive layer 512 is applied to the region 120P of the first sealant layer 120. In addition, a thickness of the second base film 521 may be less than a distance from a surface of the second base film 521 on which the second adhesive layer 522 is applied to the region 220P of the second sealant layer 220.

As described above, because the first adhesive layer 512 is configured to face and surround the region 100P of the upper case 100, the end portion 100E of the upper case 100, and the region 120P of the first sealant layer 120, the first adhesive layer 512 preferably has a thickness corresponding to the level difference formed between the upper case 100 and the first sealant layer 120. For example, the first adhesive layer 512 may have a thickness of 700 μm or more.

In addition, although it is preferable that a thickness of the first base film 511 increases as the thickness of the first adhesive layer 512 increases, in order to perform insulation of the end portion 100E of the upper case 100 by simply attaching the first taping portion 510 in the form of a tape, the thickness of the first base film 511 is preferably less than a distance from a surface of the first base film 511 on which the first adhesive layer 512 is applied to the region 120P of the first sealant layer 120.

In addition, when the thickness of the first base film 511 is excessively large, adhesion performance of the first adhesive layer 512 may be degraded, and even when the first taping portion 510 is attached, a phenomenon of lifting from an attachment target may occur.

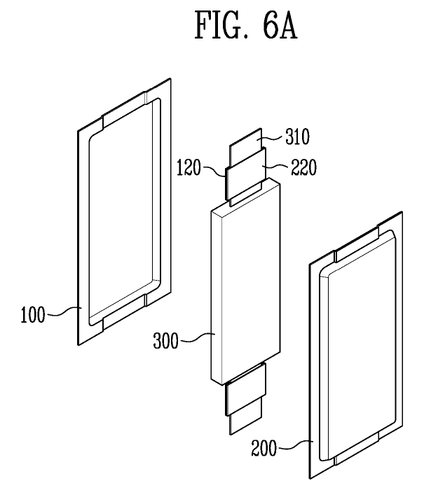

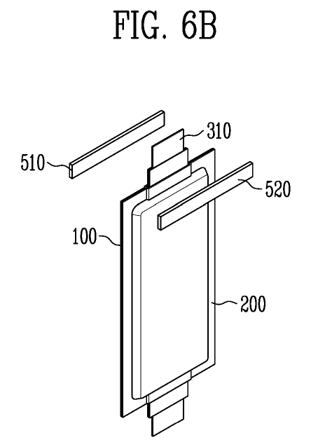

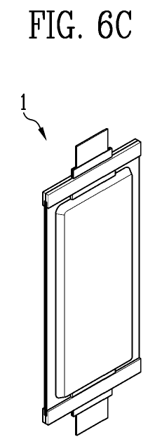

FIGS. 6A to 6C are views schematically illustrating a method of manufacturing a pouch-type battery cell 1 according to an embodiment of the present disclosure.

In an embodiment of the present disclosure, a width of the first sealant layer 120 and the second sealant layer 220 may be greater than a width of the electrode tab 310.

For example, as illustrated in FIG. 6A, the electrode assembly 300 having the electrode tab 310 formed thereon may be accommodated and sealed in a cell pouch including the upper case 100 and the lower case 200. In this case, the first sealant layer 120 and the second sealant layer 220 may be disposed in advance, in order to cover the electrode tab 310. Accordingly, the sealant layer may be interposed between the case and the electrode tab 310.

For example, in a process of sealing the upper case 100 and the lower case 200, the sealant layer may additionally provide adhesion so that the case and the electrode tab 310 may be sufficiently adhered to each other.

For example, the first polymer layer 110c of the upper case 100 may be formed of a polymer material to secure insulating properties and adhesion, and the electrode tab 310 may be formed of a metal material to secure electrical conductivity. Due to this, it is not easy for the upper case 100 and the electrode tab 310 to completely adhere to each other.

Accordingly, the first sealant layer 120 may improve adhesion between the inner first polymer layer 110c of the upper case 100 formed of different materials and the electrode tab 310, while preventing the upper case 100 from being damaged by the electrode tab 310.

For example, the sealant layer may be formed of a non-conductive material having low electrical conductivity. For example, the sealant layer may be provided in a film form and configured to surround the electrode tab 310. For example, the sealant layer may be provided in the form of a polymer resin and configured to coat an outer surface of the electrode tab 310. Accordingly, the width of the sealant layer may be greater than the width of the electrode tab 310.

For example, the sealant layer may be at least one selected from the group consisting of polyethylene, polyacetylene, PTFE, nylon, polyimide, polyethylene terephthalate, and polypropylene.

Next, as illustrated in FIG. 6B, the first taping portion 510 may be positioned in a form that simultaneously covers the region 100P of the upper case 100 and the region 120P of the first sealant layer 120, and the second taping portion 520 may be positioned in a form that simultaneously covers a region of the lower case 200 and the region 220P of the second sealant layer 220.

For example, a release liner (not illustrated) may be attached on the adhesive layer of the taping portion. The release liner may cover the adhesive layer of the taping portion to protect the adhesive component in advance, and even when covered on the adhesive layer, the release liner may be easily separated from the adhesive layer during use. Accordingly, the taping portion may be positioned such that the adhesive layer exposed after removing the release liner from the taping portion covers a region of the case and a region of the sealant layer.

Next, as illustrated in FIG. 6C, the taping portion may be attached to cover the region of the case and the region of the sealant layer, thereby completing the pouch-type battery cell 1.

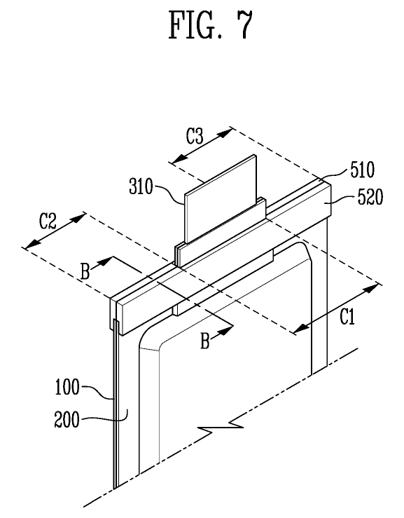

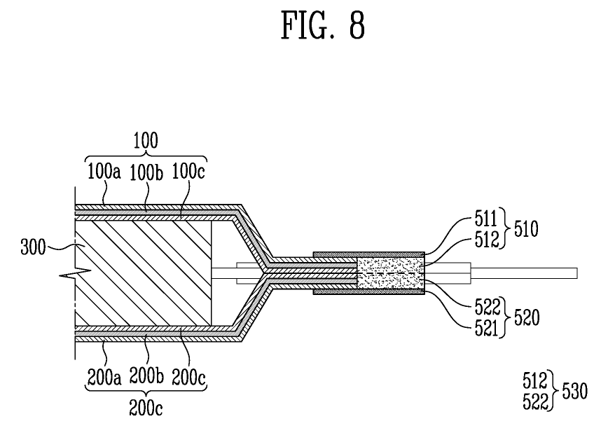

FIG. 7 is another perspective view schematically illustrating a pouch-type battery cell 1 according to an embodiment of the present disclosure. FIG. 8 is a cross-sectional view taken along line B-B of FIG. 7.

In an embodiment of the present disclosure, the first adhesive layer 512 and the second adhesive layer 522 may contact each other at a portion excluding a position where the upper case 100 and the lower case 200 respectively correspond to the first sealant layer 120 and the second sealant layer 220. Alternatively, for example, the first adhesive layer 512 and the second adhesive layer 522 may contact each other to also form a single body 530.

For example, the first taping portion 510 and the second taping portion 520 may be disposed across an entirety of the end 100E of the upper case 100 and an entirety of the end 200E of the lower case 200, respectively. Accordingly, because each of the first adhesive layer 512 and the second adhesive layer 522 of the first taping portion 510 and the second taping portion 520 may use a liquid material having viscosity, the liquid first adhesive layer 512 and the liquid second adhesive layer 522 may contact each other at a portion excluding a region physically separated by the electrode tab 310. Alternatively, for example, the liquid first adhesive layer 512 and the liquid second adhesive layer 522 may contact each other to also form a single body 530 having a unified form.

Alternatively, when the first adhesive layer 512 and the second adhesive layer 522 include a material curable by ultraviolet light, for example, when the first adhesive layer 512 and the second adhesive layer 522 contact each other to form a single body 530 having a unified form, the single body 530 may be cured by ultraviolet light in a subsequent process to also form a solid single body 530. Accordingly, rigidity of the end portion of the cell pouch may be reinforced while insulating properties of the end portion of the cell pouch may be secured.

With reference to the above description, those skilled in the art to which the present disclosure pertains will understand that the present disclosure may be implemented in other specific forms without changing the technical concept or indispensable features of the present disclosure.

Therefore, the above-described embodiments are to be understood as illustrative in all aspects and not as limiting the present disclosure to the above-described embodiments. The scope of the present disclosure is indicated by the following claims rather than the above detailed description, and all changes or modified forms derived from the meaning and scope of the claims and equivalents thereof are to be construed as being included within the scope of the present disclosure.

What is claimed is:

1. A pouch-type battery cell comprising:
a cell pouch having an upper case and a lower case accommodating an electrode assembly;
an electrode tab protruding from the electrode assembly between the upper case and the lower case;
a first sealant layer interposed between the upper case and the electrode tab, at a position corresponding to the upper case and the electrode tab;
a second sealant layer interposed between the lower case and the electrode tab, at a position corresponding to the lower case and the electrode tab;
a first taping portion covering a region of the upper case and a region of the first sealant layer; and
a second taping portion covering a region of the lower case and a region of the second sealant layer.

2. The pouch-type battery cell of claim 1, wherein each of the upper case and the lower case comprises a metal layer interposed between a first polymer layer and a second polymer layer.

3. The pouch-type battery cell of claim 1, wherein
the first taping portion comprises a first base film and a first adhesive layer applied to a surface of the first base film, and
the second taping portion comprises a second base film and a second adhesive layer applied to a surface of the second base film.

4. The pouch-type battery cell of claim 3, wherein the first adhesive layer and the second adhesive layer comprise an insulating material.

5. The pouch-type battery cell of claim 3, wherein
the first adhesive layer faces and surrounds a region of the upper case, an end portion of the upper case, and a region of the first sealant layer, and
the second adhesive layer faces and surrounds a region of the lower case, an end portion of the lower case, and a region of the second sealant layer.

6. The pouch-type battery cell of claim 5, wherein the first adhesive layer has a stepped shape forming a level difference with respect to the region of the upper case and the region of the first sealant layer.

7. The pouch-type battery cell of claim 6, wherein the first adhesive layer continuously extends from the region of the upper case to the region of the first sealant layer.

8. The pouch-type battery cell of claim 5, wherein the second adhesive layer has a stepped shape forming a level difference with respect to the region of the lower case and the region of the second sealant layer.

9. The pouch-type battery cell of claim 8, wherein the second adhesive layer continuously extends from the region of the lower case to the region of the second sealant layer.

10. The pouch-type battery cell of claim 5, wherein the first adhesive layer and the second adhesive layer are fusible by heat.

11. The pouch-type battery cell of claim 5, wherein a width of the first sealant layer and the second sealant layer is greater than a width of the electrode tab.

12. The pouch-type battery cell of claim 5, wherein the first adhesive layer and the second adhesive layer contact each other at a portion excluding a position where the upper case and the lower case respectively correspond to the first sealant layer and the second sealant layer.

13. The pouch-type battery cell of claim 5, wherein a thickness of the first base film is less than a distance from a surface of the first base film on which the first adhesive layer is applied to the region of the first sealant layer.

14. The pouch-type battery cell of claim 5, wherein a thickness of the second base film is less than a distance from a surface of the second base film on which the second adhesive layer is applied to the region of the second sealant layer.

15. The pouch-type battery cell of claim 5, wherein
a metal layer of the upper case is not exposed to an exterior by the first adhesive layer, and
a metal layer of the lower case is not exposed to the exterior by the second adhesive layer.
